(19) United States
(12) Patent Application Publication
(10) Pub. No.: US 2015/0285906 A1
(43) Pub. Date: Oct. 8, 2015

(54) PROXIMITY SENSOR

(71) Applicant: Technology Service Corporation, Silver Spring, MD (US)

(72) Inventors: William W. HOOPER, Owens Cross Roads, AL (US); Michael A. Johnson, Owens Cross Roads, AL (US)

(73) Assignee: Technology Service Corporation, Silver Spring, MD (US)

(21) Appl. No.: 14/046,346

(22) Filed: Oct. 4, 2013

Related U.S. Application Data
(60) Provisional application No. 61/709,397, filed on Oct. 4, 2012.

(51) Int. Cl. G01S 13/66; G01S 13/88; G01S 13/34; G01S 13/89; G01S 13/02; G01S 7/41

(52) U.S. Cl. CPC G01S 13/66; G01S 13/0209; G01S 7/411; G01S 13/34; G01S 13/89; G01S 13/883

(57) ABSTRACT

A forward-looking proximity sensor comprises one or more antenna elements mounted on a carrier platform in a lateral direction of said carrier platform, said antenna elements being configured to transmit a modulated signal in a direction of travel of said carrier platform, said antenna elements receiving a reflected portion of said modulated signal from said target; and a processing unit configured to generate said modulated signal based on a baseband signal and a carrier signal, said processing unit further determining characteristics of said target based on said reflected portion of said modulated signal, said characteristics of said target indicating a range of said target and at least one feature of said target.

### RELATED APPLICATION(S)

This application claims the benefit of priority to U.S. Provisional Application No. 61/709,397, filed Oct. 4, 2012, which is incorporated by reference herein in its entirety.

### FIELD OF THE INVENTION

This disclosure relates to radar systems in general and proximity sensor based on radar sensing in particular.

### BACKGROUND OF THE INVENTION

Radar sensors uses radio signals to detect targets. By analyzing the radio signals reflected from the targets, radar sensors may extract information about the targets, such as their shapes, sizes, velocities, etc. Radar sensors may serve as proximity sensors to determine a distance or proximity of a target based on the reflected signals. Conventional proximity sensors determine the proximity of a target based on a transmission delay of the radio signals reflected from the target or based on a Doppler frequency of the reflected signals.

For example, missile systems may use proximity sensors to trigger a warhead when the missile platform is in a position to have the warhead become lethal to the target. Conventional proximity sensors for missile systems have a narrow field of view that is typically directed to a side of the carrier platform. The conventional side-looking proximity sensor only allows sensing of the time the carrier platform crosses the target based on a point of closest approach. The conventional side-looking sensor may be realized by using Doppler beam sharpening that uses the Doppler frequency associated with the target to determine when the carrier platform passes the point of closest approach or when the slope of the Doppler curve changes. These conventional proximity sensors, however, do not allow for robust discrimination of target characteristics such as length, shape, orientation, etc. Conventional proximity sensors also perform poorly in a stressing environment, which may include, for example, multiple objects, high-speed objects, adverse weather conditions, interferences from other radiation sources, etc.

### SUMMARY OF THE INVENTION

In accordance with an embodiment, a forward-looking proximity sensor comprises one or more antenna elements mounted on a carrier platform in a lateral direction of said carrier platform, said antenna elements being configured to transmit a modulated signal in a direction of travel of said carrier platform, said antenna elements receiving a reflected portion of said modulated signal from said target; and a processing unit configured to generate said modulated signal based on a baseband signal and a carrier signal, said processing unit further determining characteristics of said target based on said reflected portion of said modulated signal, said characteristics of said target indicating a range of said target and at least one feature of said target.

In accordance with an embodiment, the characteristics of the target include an angle of arrival of the target with respect to the direction of travel of the platform.

In accordance with another embodiment, a method of detecting proximity of a target comprises: forming a modulated signal based on a baseband signal and a carrier signal; transmitting said modulated signal through one or more antenna elements towards a target in a direction of travel of a carrier platform, said one or more antenna elements being mounted on said carrier platform in a lateral direction of said carrier platform; receiving a reflected portion of said modulated signal from said target; and determining characteristics of said target based on said portion of said reflected portion of said modulated signal, said characteristics of said target indicating a distance to said target and at least one feature of said target.

In accordance with another embodiment, a system for detecting a target comprises: a carrier platform traveling in a direction and a forward-looking proximity sensor disposed on said carrier platform. Said forward looking proximity sensor comprises: one or more antenna elements mounted on said carrier platform in a lateral direction of said carrier platform and configured to transmit a modulated signal in said direction of traveling of said carrier platform, said antennas receiving a reflected portion of said modulated signal from said target; and a processing unit configured to generate said modulated signal based on a baseband signal and a carrier signal, said processing unit further determining characteristics of said target based on said reflected portion of said modulated signal, said characteristics of said target indicating a distance of said target and at least one feature of said target.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the disclosure and together with the description, serve to explain the principles of the disclosure.

### BRIEF DESCRIPTION OF THE DRAWINGS

FIG. 1 illustrates a diagram of a proximity sensor, according to an embodiment;

FIG. 2 illustrates a diagram of a baseband waveform for forming a modulated signal, according to an embodiment;

FIG. 3 illustrates an exemplary range-Doppler image formed by the proximity sensor of FIG. 1, according to an embodiment;

FIG. 4 illustrates a range signal generated by the proximity sensor of FIG. 1, according to an embodiment;

FIG. 5 illustrates a diagram of a proximity sensor, according to another embodiment;

FIG. 6 illustrates a range signal generated by the proximity sensor of FIG. 5, according to an embodiment;

FIG. 7 illustrates a diagram of a proximity sensor, according to still another embodiment;

FIG. 8 illustrates a process of generating a range-Doppler image by a proximity sensor, according to an embodiment;

FIG. 9 illustrates an exemplary engagement process of a missile system carrying a proximity sensor, according to an embodiment;

FIG. 10 illustrates a conformal antenna array for the proximity sensor, according to an embodiment;

FIG. 11 illustrates a two-way beam pattern of the conformal antenna array of FIG. 10, according to an embodiment;

FIG. 12 illustrates a frequency response of the conformal antenna array of FIG. 10, according to an embodiment;

FIG. 13A illustrates a top view of an antenna array configured to measure an angle of arrival of a target, according to an embodiment;

FIG. 13B illustrates an end view of an antenna array configured to measure an angle of arrival of a target, according to an embodiment;

FIG. 14 illustrates a carrier platform having a proximity sensor disposed therein, according to an embodiment;

FIG. 15 illustrates range-Doppler images for various fall angles generated by a proximity sensor operating as a height-of-burst (HOB) sensor, according to an embodiment;

FIG. 16 illustrates set points determined by a conventional. HOB sensor and an HOB sensor according to an embodiment of the disclosure; and

FIG. 17 illustrates a missile system equipped with an HOB sensor operating in a single set point mode, according to an embodiment.

### DESCRIPTION OF THE EMBODIMENTS

Reference will now be made in detail to the present embodiments of the disclosure, examples of which are illustrated in the accompanying drawings. Wherever possible, the same reference numbers will be used throughout the drawings to refer to the same or like parts.

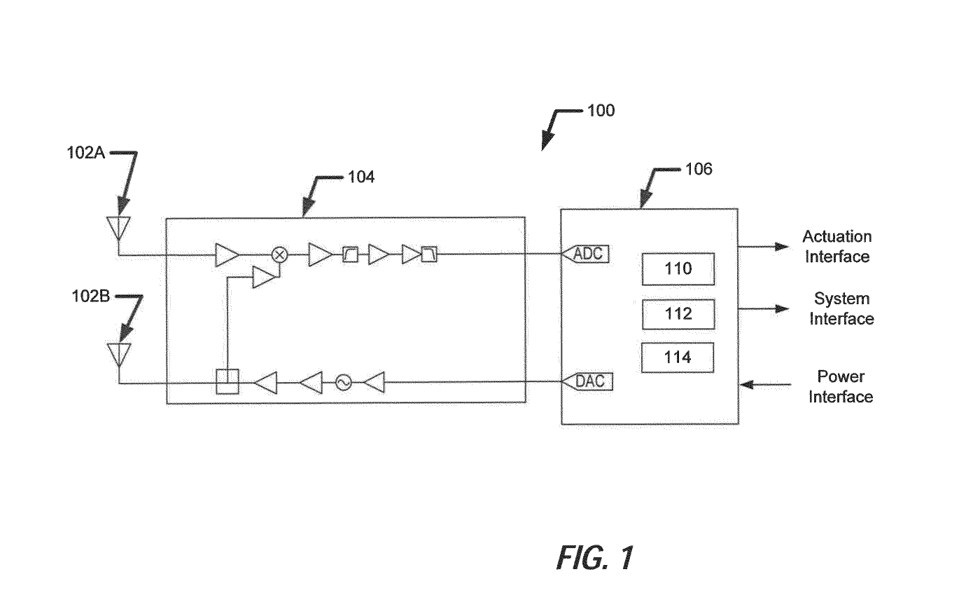

FIG. 1 illustrates a schematic diagram of an exemplary proximity sensor 100 according to an embodiment. Proximity sensor 100 includes one or more antennas 102A and 102B, an analog module 104, and a processing module 106. Antennas 102A and 102B may each be configured to transmit as well as receive signals, such as radio frequency (RF) signals, optical signals, laser signals, infrared signals, etc. Alternatively, one of antennas 102A or 102B may operate as a transmitting antenna configured to transmit the signals and another one of antennas 102A or 102B may operate as a receiving antenna configured to receive the signals. According to an embodiment, the signals transmitted by antennas 102A and 102B may be continuous wave (CW) signals. Alternatively, the signals transmitted by antennas 102A and 102B may be pulse signals.

According to a further embodiment, antennas 102A and 102B may be formed into desired shapes that are suitable for integration with a carrier platform, such as a vehicle, an aircraft, or a vessel. Antennas 102A and 102B may each include one or more metal sheets that may be conformed to the shape of the carrier platform or a portion thereof. Although FIG. 1 illustrates two antennas, one of ordinary skill in the art will appreciate that any number of antennas may be used in sensor 100.

Analog module 104 may include analog components configured to generate the signals that are suitable for transmission through antennas 102A and 102B and receive reflected signals through antennas 102A and 102B. More specifically, analog module 104 may receive baseband signals from processing module 106 and up convert the baseband signals to a higher frequency band that is suitable for transmission through antennas 102A and 102B. Analog module 104 may also be configured to down convert the reflected signals received through antennas 102A and 102B to baseband signals and provide the baseband signals to processing module 106 for further processing. Analog module 104 may perform the up conversion and the down conversion by way of direct conversion between the baseband frequency and the radio frequency. Alternatively, analog module 104 may perform the up conversion and the down conversion through an intermediate frequency (IF).

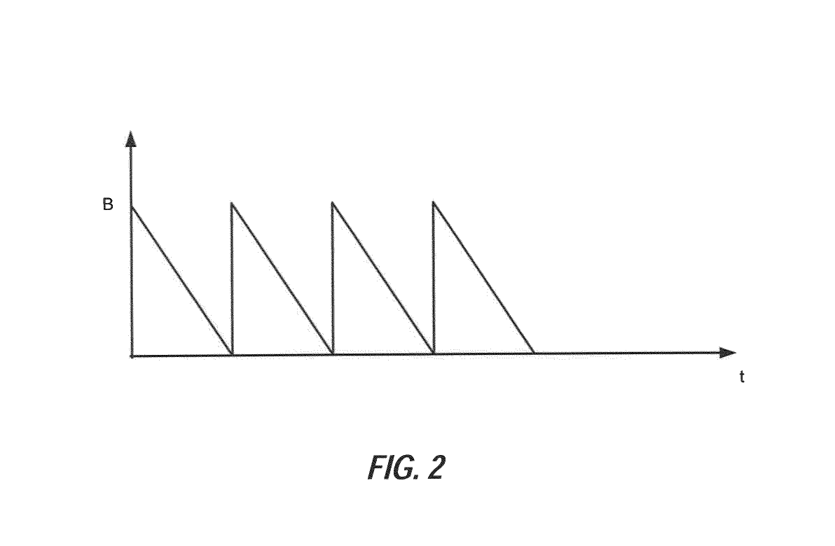

Alternatively, signals transmitted by antennas 102A and 102B may be modulated signals. Analog module 104 may generate modulated signals by modulating baseband signals to a carrier signal at a carrier frequency band according to frequency modulation. Analog module 104 may also demodulate reflected signals received through antennas 102A or 102B to recover baseband signals. According to an embodiment, analog module 104 may use frequency modulation and demodulation for conversion between baseband signals and modulated signals. In an embodiment, baseband signals may include a sawtooth waveform as shown in FIG. 2. As a result, analog module 104 may carry out frequency modulation by linearly varying or sweeping the frequency of the carrier signal within a frequency band B. In alternative embodiments, baseband signals may include other linear or nonlinear waveforms known in the art. Thus, analog module 104 may carry out frequency modulation according to the linear or nonlinear waveforms.

According to a further embodiment, analog module 104 may include one or more beam formers configured to control the timing and phases of the signals transmitted through antennas 102A and 102B. The one or more beam formers may control the signals to form beam in a desired direction towards a target. The one or more beam formers may change the direction of beam so as to allow signals to track target. According to a further embodiment, beam former may cause antennas 102A and 102B to transmit the signals in substantially the direction of travel of carrier platform. Thus, system 100 may have a forward-looking field-of-view.

According to an additional embodiment, analog module 104 may further include filtering components for removing or suppressing undesired signal components. For example, analog module 104 may include one or more low-pass filter(s), high-pass filter(s), or band-pass filter(s) configured to retain only signals at a desired frequency band. Analog module 104 may further include power amplifier(s) for increasing the signals components to a level that is suitable for transmission through antennas 102A and 102B or for subsequent processing by processing module 106. Analog module 104 may further include other circuit components, such as a voltage-controlled oscillator (VCO), suitable for generating carrier frequency signals.

Processing module 106 may be configured to generate baseband signals with desired characteristics, such as frequencies, amplitudes, and phases and transmit the baseband signals to analog module 104 for further conversion to the signals suitable for transmission. According to an embodiment, processing module 106 may include digital signal processor 110 and memory 112. Memory 112 may be configured to store instructions and data relevant to the processing and generation of the digital signals. Processor 110 may be configured to execute instructions to process and generate digital signals. Memory 112 may include ROM, RAM, flash memory, or other computer-readable media known in the art. Processor 110 may include general-purpose processor, such as an INTEL processor, or proprietary signal processor designed to generate and processing the digital signals. Alternatively, processor 110 may include programmable logic device, such as a field programmable gate array (FPGA) or application-specific integrated circuit (ASIC), that may be specifically configured to provide the functions described herein in connection with the processing of the digital signals.

According to a further embodiment, processing module 106 may include digital-to-analog convertor (DAC) for converting digital signals generated by processor 110 to the baseband signals for further processing by analog module 104. Additionally, processing module 106 may include analog-to-digital convertor (ADC) configured to convert the baseband signals received from analog module 104 to the digital signals for processing processor 110.

According to a further embodiment, processing module 106 may determine characteristics of target based on a portion of the transmitted signals that is reflected from target and received by receiving antenna. For example, processing module 106 may determine distance or range, velocity, shape, surface property, or other characteristics of the target based on reflected signals from target. According to an embodiment, processing module 106 may determine characteristics of target based on a time difference between the transmission of output signals and reception of reflected signals. Processing module 106 may then calculate range of the target based on time difference and speed of the signals. According to another embodiment, processing module 106 may determine characteristics of the target based on Doppler processing of the received signals. The Doppler processing will be further described hereinafter.

Processing module 106 may further track the target based on characteristics of target. For example, processing module 106 may update characteristics of target periodically based on the received signals to estimate location, distance, range, velocity, size, or orientation of target or features thereof. As another example, processing module 106 may also calculate angle of arrival or “look angle” of target with respect to a direction of travel of carrier platform. Processing module 106 may perform the estimation based on known techniques, such as Kalman filtering.

According to a further embodiment, processing module 106 may have decision module 114 configured to determine triggering events for carrier platform based on characteristics of target determined by processing module 106. For example, decision module 114 may estimate time of impact between platform and target. Decision module 114 may also determine course or trajectory for carrier platform to aim platform at target or cause platform to avoid target. Decision module 114 may also determine optimal detonation time or fire time to fuze the platform to maximize damage to target.

Sensor 100 may further include interface(s) for communication with other systems onboard carrier platform. For example, sensor 100 may receive electric power through power interface from battery or electrical source onboard carrier platform. Sensor 100 may communicate with global positioning system (GPS) of carrier platform though system interface to receive data indicating location of carrier platform. Interface module 108 may also communicate with actuation system of carrier platform through actuation interface to adjust operation of carrier platform according to determination results of decision module 114. Sensor 100 may communication with, for example, fuze/firing system, rocket booster, braking system, engine, steering system, motor, robotic arm, etc. Through the interfaces, sensor 100 may cause actuation system of carrier platform to perform certain actions or operations based on characteristics of target. For example, sensor 100 may cause warhead of carrier platform to detonate at calculated time or distance from target. System 100 may also cause carrier platform to accelerate or decelerate by varying power generated by rocket booster, engine, motor, or braking system of carrier platform. System 100 may also cause carrier platform to change course or direction by controlling lateral thruster or steering system of carrier platform.

According to a still further embodiment, sensor 100 may communicate through interface(s) with command system external to carrier platform. For example, sensor 100 may communicate with command system located on the ground or onboard another vehicle, aircraft, or vessel. Sensor 100 may receive communication signals from external command system or transmit the characteristics of target determined by processing module 106 to external command system. Thus, sensor 100 may allow external command system to control carrier platform. For instance, sensor 100 may receive communication signals from external command system, which causes carrier platform to operate according to communication signals. Sensor 100 may also receive communication signals to update instructions and data stored in memory 112.

According to a further embodiment, forward-looking proximity sensor 100 may be integrated with missile system to provide the benefit of “watching” the target as missile comes in for the kill. Newer targets such as unmanned aerial vehicles (UAVs) and artillery with smaller cross sections and hardened warheads require increased accuracy with regard to aim points. Unlike conventional proximity sensors, forward looking proximity sensor 100 provides more accurate measurements during the homing phase of missile's trajectory. Proximity sensor may accurately predict the optimal detonation point, which may increase the lethality for target.

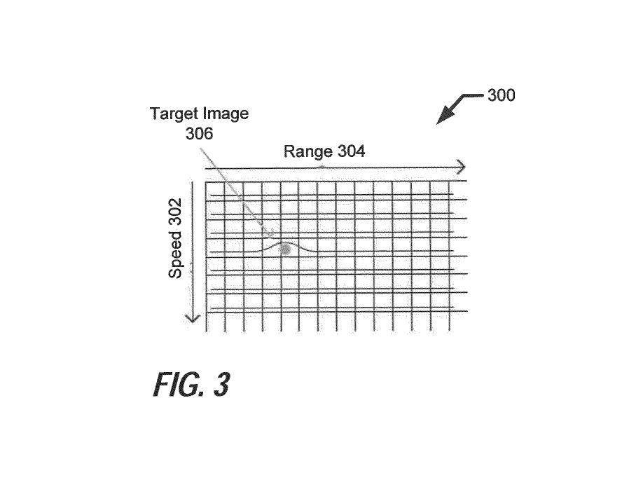

According to a further embodiment, sensor 100 may be configured to generate two-dimensional range-Doppler image of target. FIG. 3 illustrates an exemplary range-Doppler image 300 that may be generated by sensor 100 according to an embodiment. Range-Doppler image 300 includes pixel array defined by first dimension 302 representing the speed of target and second dimension 304 representing range of target. Each pixel includes a value indicating signal energy returned from a corresponding target point within sensor's field of view. The location of each pixel within pixel array corresponds to speed and range of target point that returns signal energy. When target enters sensor's field of view, range-Doppler image 300 may show target image 306 of target. Target image 306 may include one or more pixels that indicate shape and structure of target. By analyzing range-Doppler image 300, sensor 100 may determine various characteristics of target, such as speed, range, shape, size, etc. Sensor 100 may further identify different features, structures, or portions of the target based on analysis of target image 306.

According to another embodiment, sensor 100 may be low bandwidth sensor. Low bandwidth sensor is configured to detect presence of target and determine distance between carrier platform and a point of target that is closest to carrier platform.

According to another embodiment, analog module 104 and processing module 106 may be integrated into processing unit including both analog and digital components. Processing unit may include circuit boards having circuit components affixed thereon. Processing unit may further include standard or proprietary interface components for providing actuation interface, system interface, and power interface described above.

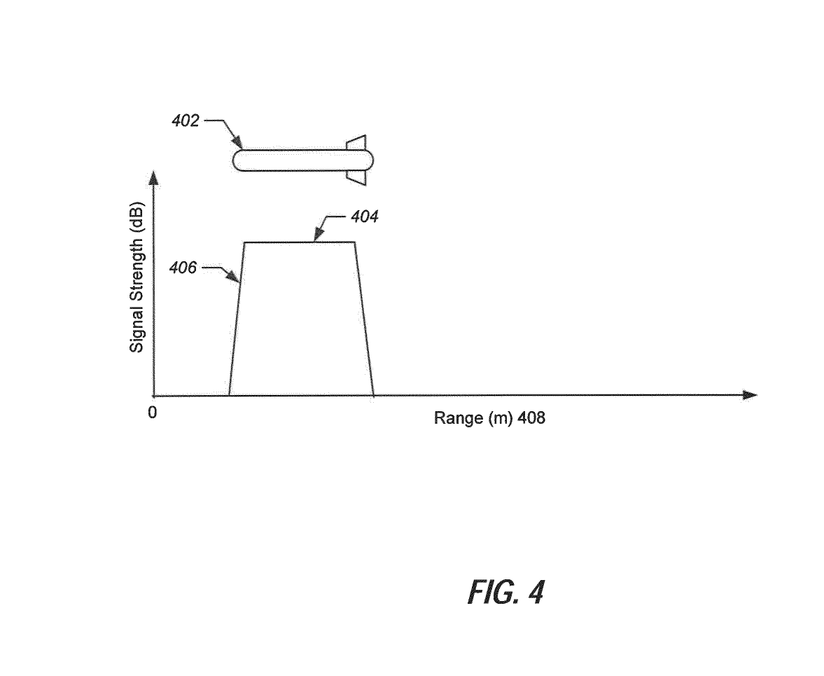

FIG. 4 illustrates an exemplary range signal 404 generated by low bandwidth sensor in response to target 402. Range signal 404 is defined with respect to range axis 408 that indicates distances between carrier platform and various portions of target 402. As further shown in FIG. 4, range signal 404 may include a variation in signal strength 406, such as a rising edge or a falling edge, which corresponds to a portion of target 402 that is closest to carrier platform. Thus, by detecting signal variation 406 in range signal 404, sensor 100 may identify target 402 and determine distance to target 402. Sensor 100 may generate range signal 404 as part of range-Doppler image shown in FIG. 3. For example, sensor 100 may extract range signal 404 from range-Doppler image at a particular speed.

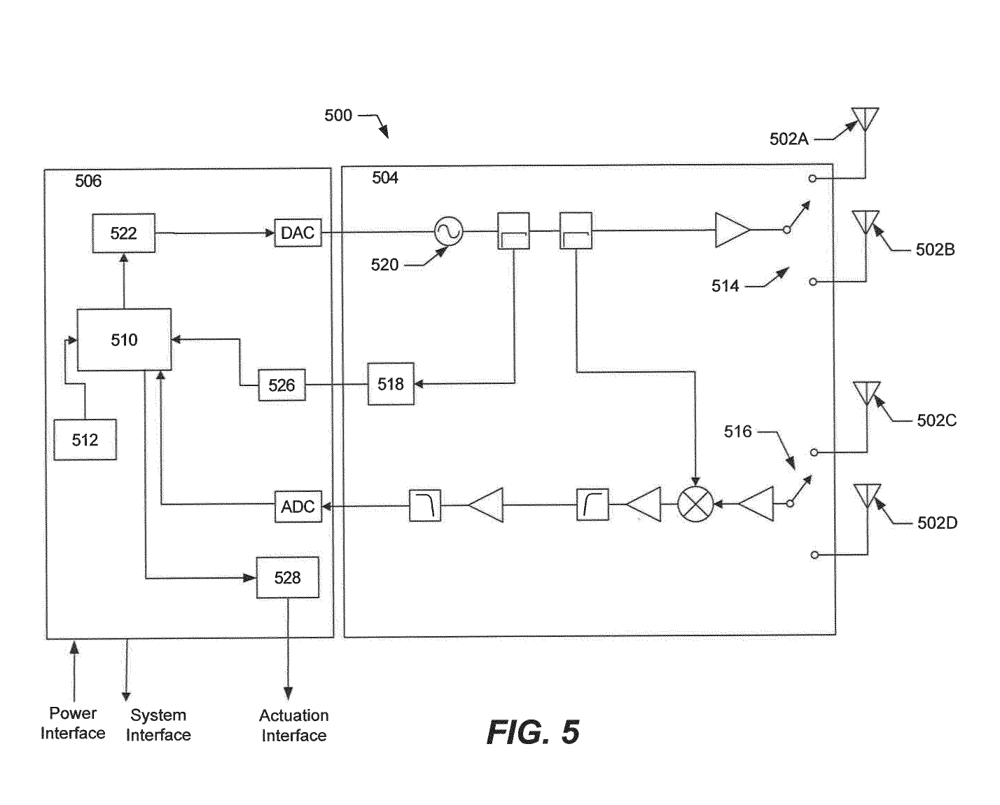

FIG. 5 illustrates another exemplary proximity sensor 500 based on high range-resolution homodyne system, according to an embodiment. Proximity sensor 500 includes one or more antennas 502A-502D, analog module 504, and processing module 506. Antennas 502A-502D are separated into transmitting array formed by antennas 502A and 502B and receiving array formed by antennas 502C and 502D.

According to another embodiment, antennas 502A-502D may be highly diversified in order to provide reliable signal transmission and reception. For example, antennas 502A-502D may be disposed on different portions of the carrier platform and directed to different directions. Sensor 500 may monitor operation of each antenna and select antenna with, for example, the greatest signal-to-noise ratio (SNR). Sensor 500 may include switch 514 for selecting antennas 502A or 502B for transmitting signals and switch 516 for selecting antennas 502C or 502D for receiving reflected signals.

According to a further embodiment, sensor 500 may use a Linear Frequency Modulated (LFM) waveform with a wide frequency band. Accordingly, analog module 504 of sensor 500 may have a much wider frequency range than analog module 404 of sensor 400. Separate analog-to-digital and digital-to-analog converters may accommodate the bandwidth of the received and transmitted signals along with a processor 510 to provide computational power for signal processor and tracking algorithms. Processor 510 may be FPGA, ASIC, or other processor known in the art. Sensor 500 may further include memory 512 for storing instructions that may be executed by processor 510.

According to another embodiment, sensor 500 may include signal feedback for automatic calibration. More particularly, analog module 504 may include voltage-controlled oscillator (VCO) 520 for generating a waveform signal to be transmitted through antenna 502A or 502B or to be converted to a modulated signal described above. Analog module 504 may further include signal divider 518 for returning a portion of the waveform signal. The portion of the waveform signal returned by signal divider 518 may be processed by a frequency control unit 526. Processor 510 may analyze signals from frequency control unit 526 to determine whether the waveform signal has desired characteristics, such as predetermined frequency or phase. This may be performed by any frequency detecting circuit, such as a frequency counter, as known in the art. Frequency control unit 526 may be implemented as part of processor 510 and integrated therein. When determining that characteristics of the waveform signal deviate from desired values, processor 510 may control VCO 520 to recalibrate the waveform signal. Processor 510 may control VCO 520 through sweep generation unit 522. Processor 510 may further adjust the frequency of the waveform signal generated by VCO 520 in set frequency range so as to allow sensor 500 to operate in relatively wide bandwidth. In general, wider bandwidth allows sensor 500 to generate finer-resolution signal and to identify greater details of target. Thus, signal divider 518 and frequency control unit 526 provide signal feedback from VCO 520 to processor 510, which allows sensor 500 to operate in a wide temperature range and in different aging conditions.

According to another embodiment, sensor 500 may include actuation unit 528 that may communicate with actuation interface for generating actuation signal for controlling operation of carrier platform. Sensor 500 may further communicate with other systems of carrier platform through system interface and receive electrical power through power interface as described above in connection with FIG. 1.

According to an embodiment, sensor 500 may be high bandwidth sensor that is capable of not only detecting the presence and the distance of target, but also identifying individual features, structures, portions, or other characteristics of target. For example, when sensor 500 is coupled to missile system, sensor 500 may track the target during an engagement as well as guide missile system to aim at a particular portion of target so as to maximize lethality.

Sensor 500 may identify a track point based, for example, on one portion of signals returned from target and identify an aim point based on another portion of signals returned from target. High bandwidth of sensor 500 allows processing unit 504 to identify specific surface features based on returned signals. For example, sensor 500 may identify variation of cross-sectional dimension of target, reflectivity of surface of target, structural variation of surface of target, etc.

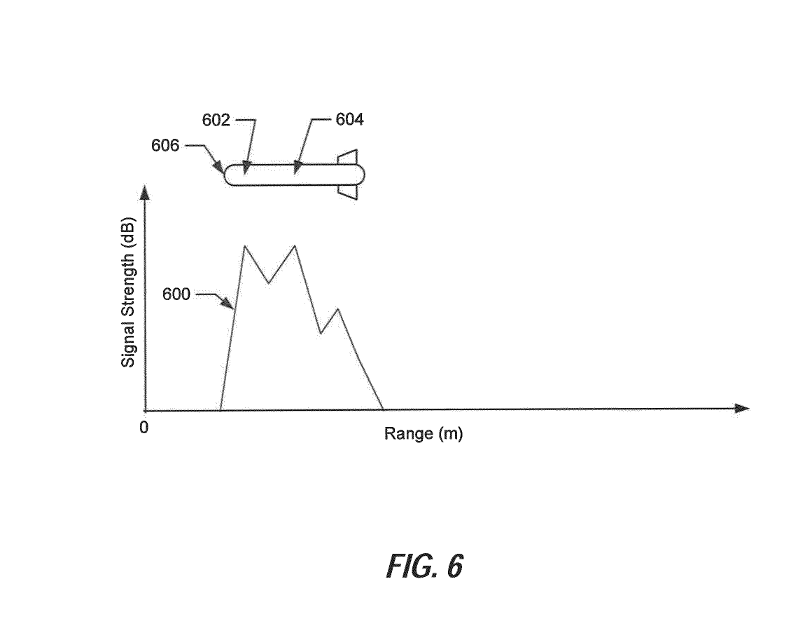

High-bandwidth sensors, such as sensor 500, are employed when a specific part of target must be identified. As shown in FIG. 6, sensor 500 may generate high-resolution range signal 600 that includes details corresponding to different portions or structures of target 606. Based on range signal. 600, sensor 500 may identify separate points on target 606, such as track point 604 and aim point 602. Sensor 500 may then track target 606 during the engagement based on track point 604, while creating a firing solution for carrier platform base on aim point 602 so that it may impact a desired portion of target 606.

According to another embodiment, sensor 500 may also determine velocity (including speed and direction of travel) of target, size of target, shape of target, and angle of arrival of target with respect to a line of sight between carrier platform and target. In another embodiment, sensor 500 may also determine surface properties of target, such as reflectivity.

According to a further embodiment, low-bandwidth sensor and high-bandwidth sensor described above may be selected for particular carrier platform depending on target characteristics. For targets that may be tracked and aimed using the same point, low-bandwidth sensor may be used. For targets that are tracked and aimed using different points, high bandwidth sensor may be used.

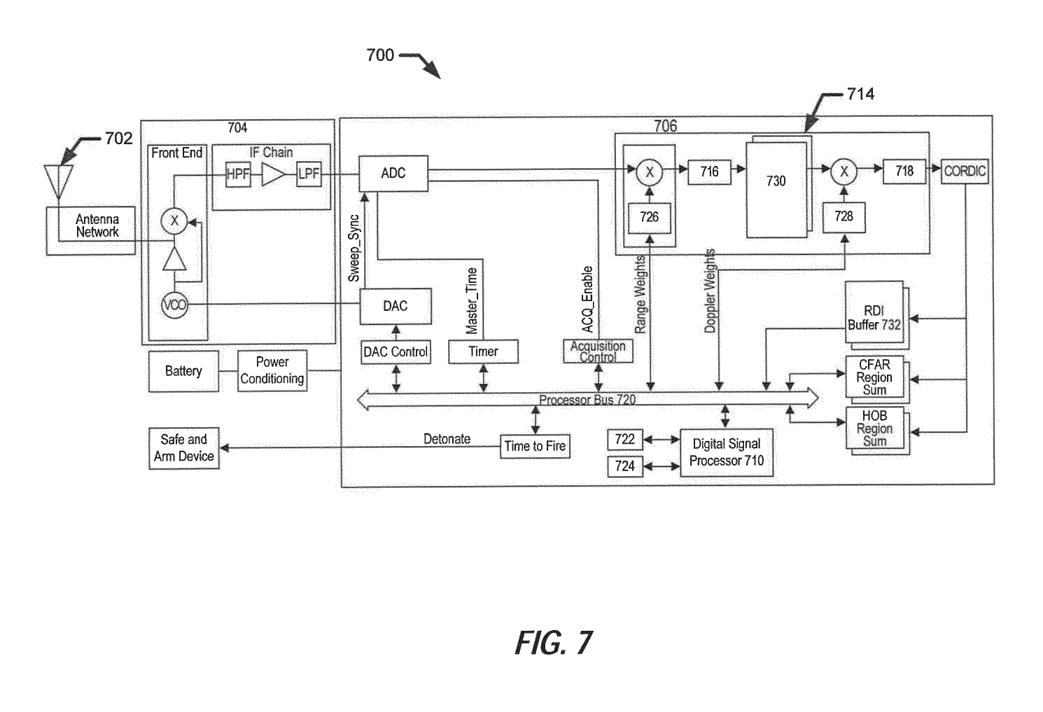

FIG. 7 shows another exemplary forward-looking proximity sensor 700 according to an embodiment. Proximity sensor 700 includes antenna network 702, analog module 704, and processing module 706. Antenna network 702 may include one or more antennas suitable for transmitting and receiving signals. The signals may include Linear FMCW (LFMCW) or other modulated or un-modulated signals.

According to a further embodiment, processing module 706 may include image processor 714 configured to generate the range-Doppler image similar to that shown in FIG. 3. Image processor 714 may include dedicated circuits for performing Fast Fourier Transform (FFT). According to a further embodiment, image processor 714 may generate range-Doppler image with pixel array of desired size including a plurality of rows and a plurality of columns. Accordingly, image processor 714 includes first FFT module 716 configured to perform a multi-point FFT for rows of pixel array and a second FFT module 718 configured to perform a multi-point FFT for columns of pixel array. Image processor 714 may communicate with processor bus 720 to receive parameters, such as range weights and Doppler weights, for calculating the range-Doppler image. Image processor 714 may receive parameters from digital signal processor 710 or storage medium 722 or 724. Image processor 714 may further include one or more storage media 726, 728, and 730 for storing parameters and data generated during calculation of range-Doppler image. Range-Doppler image may be stored in RDI buffer 732 for later retrieval by other system components such as digital signal processor 710.

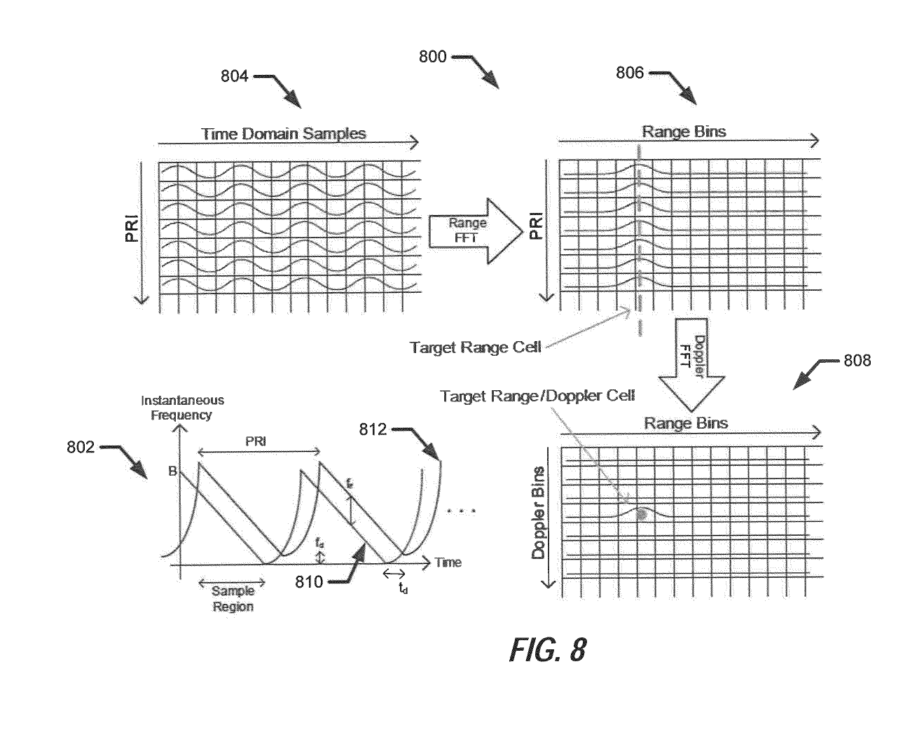

FIG. 8 shows a process 800 for generating range-Doppler image 300 according to an embodiment. Process 800 may be implemented on any one of the proximity sensors described above. According to process 800, at step 802, the proximity sensor generates modulated signal, such as linear chirp-mixed signal with sweeping frequency 810 having frequency band B. Sweeping frequency 810 may vary within frequency band B repeatedly and periodically at set Pulse Repetition Interval (PRI) as sensor transmits signal.

Proximity sensor further receives reflected signal in response to chirp-mixed signal. Due to the relative velocity between target and carrier platform, reflected signal may include frequency 812 having Doppler frequency shift f_{d}. Doppler frequency shift f_{d} may vary at different temporal portion of reflected signal because of changes in relative velocity. Thus, Doppler frequency shift f_{d} indicates relative velocity between target and carrier platform. In addition, reflected signal may also include time delay t_{d} due to the round-trip transmission time between target and carrier platform. Thus, time delay t_{d} indicates the range to target.

At step 804, the proximity sensor may acquire time-domain samples of reflected signal and arrange samples in storage medium, such as buffer. The samples may be arranged in a two-dimensional matrix that has a first dimension representing the time domain and a second dimensional representing the Pulse Repetition Interval.

At step 806, the proximity sensor may perform range FFT on time domain samples within each RPI resulting in complex range/PRI samples, which form Range-Time Image (RTI). At step 808, proximity sensor performs Doppler FFT across PRI domain for each range bin resulting in final range-Doppler image.

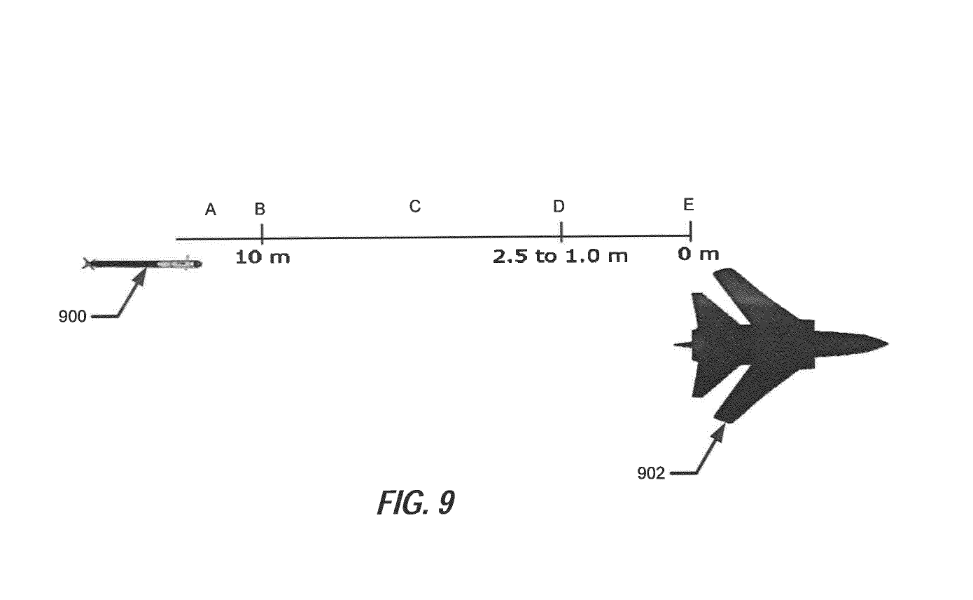

According to an embodiment, proximity sensors described above in connection with FIGS. 1-8 may operate as a forward-looking proximity sensor for guiding the carrier platform, such as missile or other projectile, towards target. The forward-looking proximity sensor may provide optimal detonation decision to maximize damage to target. FIG. 9 depicts an exemplary embodiment of a missile system 900 equipped with forward-looking proximity sensor similar to that described above. FIG. 9 illustrates missile system 900 on course to engage with target 902.

Conventional proximity sensor would trigger detonation of missile at Doppler threshold or trip wire as missile flies by target. The proximity sensor described herein, however, provides forward-looking field of view that allows the sensor to “watch” target as missile comes in for the kill. By integrating measurements during the homing phase of missile's trajectory, proximity sensor can accurately predict optimal detonation point which creates the greatest lethality for warhead.

The basic timeline and actions provided by proximity are further shown in FIG. 9. More specifically, at stage A, proximity sensor may transmit outbound signals, such as FMCW signals, in direction of travel of a carrier platform, such as missile system 900. Proximity sensor monitors reflected portion of outbound signals from target 902 to determine characteristics of target 902, such as range and speed of target 902. At stage B, the proximity sensor may detect that range of target 902 is less than threshold value, such as 10 meters, at which track quality is sufficient to allow proximity sensor to track target 902. At stage C, proximity sensor may start tracking target 902 and project position of target 902 using tracker, such as α-β tracker or Kalman filter as known in the art. At stage D, proximity sensor may determine an operation for the carrier platform, such as calculating a fire solution, based on tracking data. Proximity sensor may initiate calculation when tracking data fidelity is optimal at about 2.5 to 1.0 meter from target 902, depending on closing velocity between missile 900 and target 902.

At stage E, the proximity sensor may cause the carrier platform to execute the operation according to the determination at stage D. For example, the proximity sensor may issue detonation signal to trigger detonation of missile 900. The proximity sensor may issue detonation signal when the carrier platform reaches the RF centroid or when an impact between missile 900 and target 902 is detected. Alternatively, the proximity sensor may issue the detonation signal when the carrier platform is at a specific distance to target 902 before or after crossing the RF centroid. Still alternatively, the proximity sensor may identify a particular feature or structure of target 902 when operating in a high-resolution mode. Accordingly, the proximity sensor may measure a distance between the carrier platform and the identified feature or structure of target 902 and issue the detonation signal according to the distance to the identified feature or structure of target 902.

The proximity sensor described above may be used to not only enable low-cost forward-looking proximity fuzing or high-range-resolution (HRR) aim point resolved fuzing, but also can reuse processing resources during different phases of flight to enable communication, radar cross section (RCS) enhancement, and seeker functions. Since proximity sensor is configured to track target for a substantial amount of time prior to fuzing, fuze can take advantage of information about target supplied by other guidance system, such as onboard seeker, ground radar, etc., to refine fuzing solution based on engagement geometry, target orientation, or target type.

Since many missile systems utilize seeker to provide guidance information to maneuver platform into position to intercept target, front ends of the missile systems are often occupied with antennas, optics, and other electronics utilized by seeker systems. Therefore, antennas, data links, telemetry, and other system components of proximity sensors described herein may be disposed behind existing seeker and further away from the front end of the missile system.

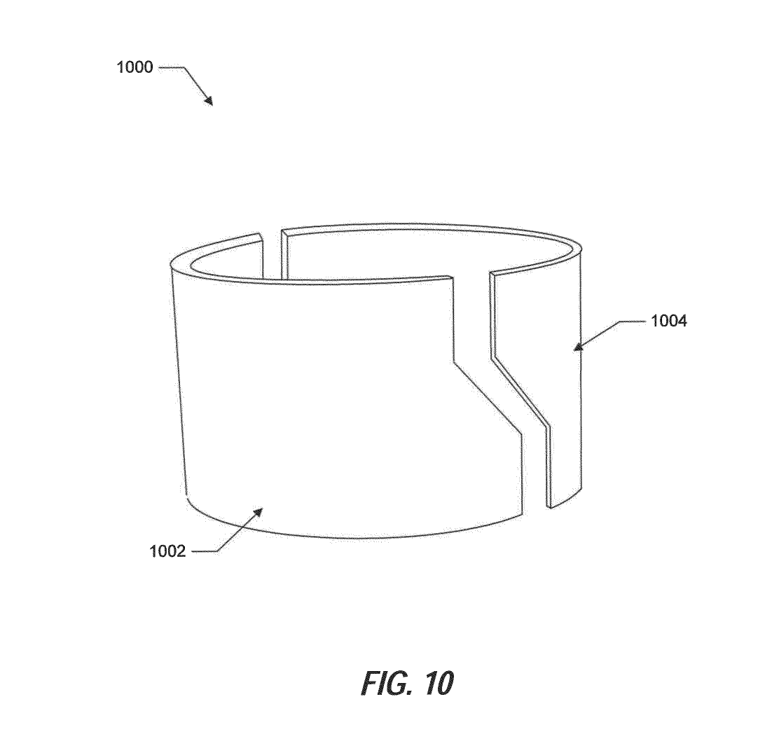

According to a further embodiment, proximity sensors described herein may include conformal antenna array 1000 as depicted in FIG. 10. Conformal antenna array 1000 may include one or more flat metal sheet radio antenna elements configured to conform or follow prescribed shape. For example, flat metal sheet antenna elements may be curved to conform to the shape of cylindrical body of missile and mounted on the side in a lateral direction of cylindrical body of carrier platform or wrapped around a portion of cylindrical body.

According to an embodiment, conformal antenna array 1000 is configured to provide a forward-looking beam pattern that is directed in the direction of travel of carrier platform, rather than a lateral direction as in a conventional proximity sensor. The forward-looking beam pattern may enable proximity sensor to have enhanced field of view to make accurate range and velocity measurements of target. Typically this pattern matches the field-of-view of onboard seeker, so that both proximity sensor and seeker can view target at the same time. Seeker may guide missile system to target, while proximity sensor may determine an optimal firing solution for warhead carried thereon.

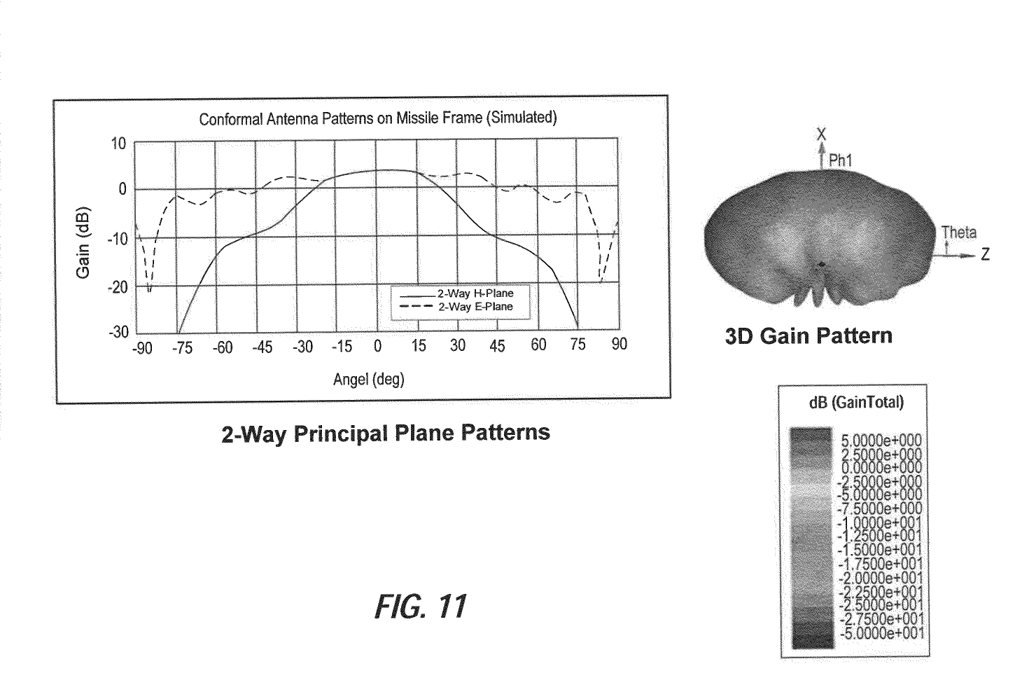

According to a further embodiment, conformal antenna array 1000 may include transmitting element 1002 and receiving element 1004. Transmitting element 1002 and receiving element 1004 may be disposed 180 degrees apart on missile body and provide two-way forward-looking beam pattern as depicted in FIG. 11. The overall gain of antenna 1000 is given by the two-way pattern between transmitting and receiving elements 1002 and 1004. As further shown in FIG. 11, two-way forward-looking beam pattern is relatively uniform in a forward cone and may be tailored to suit particular systems.

According to a further embodiment, additional antenna elements may be added to allow polarization diversity and to mitigate shadowing effects on relatively large carrier platforms. In addition, the placement of transmitting and receiving antennas 1002 and 1004 at a 180 degree offset increases antenna isolation by placing one element in the nulls of another element, thereby providing improved performance. According to a further embodiment, multiple pairs of antenna elements as shown in FIG. 10 may are used in a sequential fashion to improve overall system performance without the problem of nulls in the beam pattern that is typically associated with conventional antenna arrays.

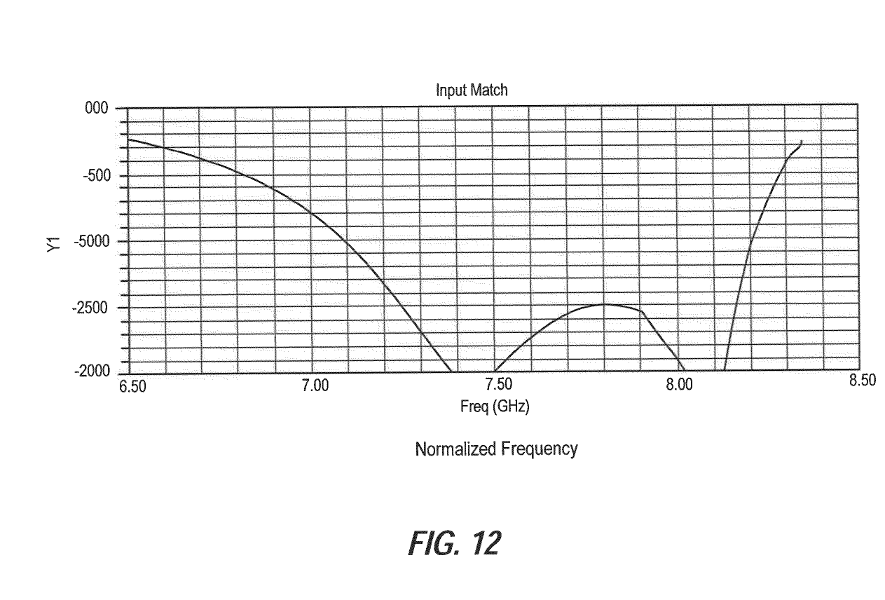

Furthermore, bandwidth of conformal antenna array 1000 is determined by a number of parameters such as material thickness, aperture, or geometry of each antenna element. A plot of exemplary frequency response of conformal antenna array 1000 is shown in FIG. 12. The material used for conformal antenna array 1000 may enhance cost-effectiveness and may be readily available at printed board fabrication houses combined with standard flat panel manufacturing techniques. Thus, combination of these two aspects provides a low cost and reliable antenna array. Once the elements of antenna array 1000 are fabricated, they are conformed to a shape of carrier platform, such as missile body. For example, antenna array 1000 may be formed into cylindrical shape that conforms to a section of missile body. Beam pattern formed by antenna array 1000 may be steered along axial direction of cylindrical shape. According to a further embodiment, each element of antenna array 1000 may include multiple layers that are developed utilizing the same technique for accommodating feed structures. Standard conductive and nonconductive adhesives may be used to assemble the multiple layers.

According to a further embodiment, proximity sensor described herein may provide an additional detonation mode to missile system in addition to primary detonation mode. For a hit-to-kill missile, proximity sensor may detect a miss and detonate missile when the miss has occurred. In this manner, lethality may be enhanced for targets while preserving the primary mission of missile. Proximity sensor operates in conjunction with existing seeker systems to provide more integration time on target. Proximity sensor continues to estimate range and velocity of target as missile approaches target and allows for greater detonation accuracy.

According to another embodiment, proximity sensor described herein may use linear engagement geometry to estimate range and speed of target prior to reaching non-linear region of engagement. Linear engagement geometry simplifies firing solution calculations and increases lethality over conventional side-looking proximity sensors that must operate in non-linear engagement regions. Thus, proximity sensor described herein provide simpler and more accurate estimate of target aimpoint.

According to another embodiment, proximity sensor may collect and process information about target during the endgame (i.e., the final portion of engagement between missile and target). Based on the information, proximity sensor forms a better estimate of the time of crossing between missile warhead and target aim point than conventional side-looking proximity sensors. Two-way beam pattern between transmitting and receiving antennas allows conformal antenna to focus energy in the direction of target. The field-of-view of proximity sensor may be set by existing seeker and guidance parameters.

According to a further embodiment, to prevent shadowing and handle polarization effects, conformal antenna array of proximity sensor may include a plurality of sets of transmitting/receiving antenna pairs with different polarities, locations, and parameters. During the endgame, transmitting/receiving antenna pairs may be alternated every Coherent Processing Interval (CPI) by an RF switch that is synced to firmware of proximity sensor. In this embodiment, the proximity sensor may provide a forward-looking field of view with an estimation of an angle of arrival of the target.

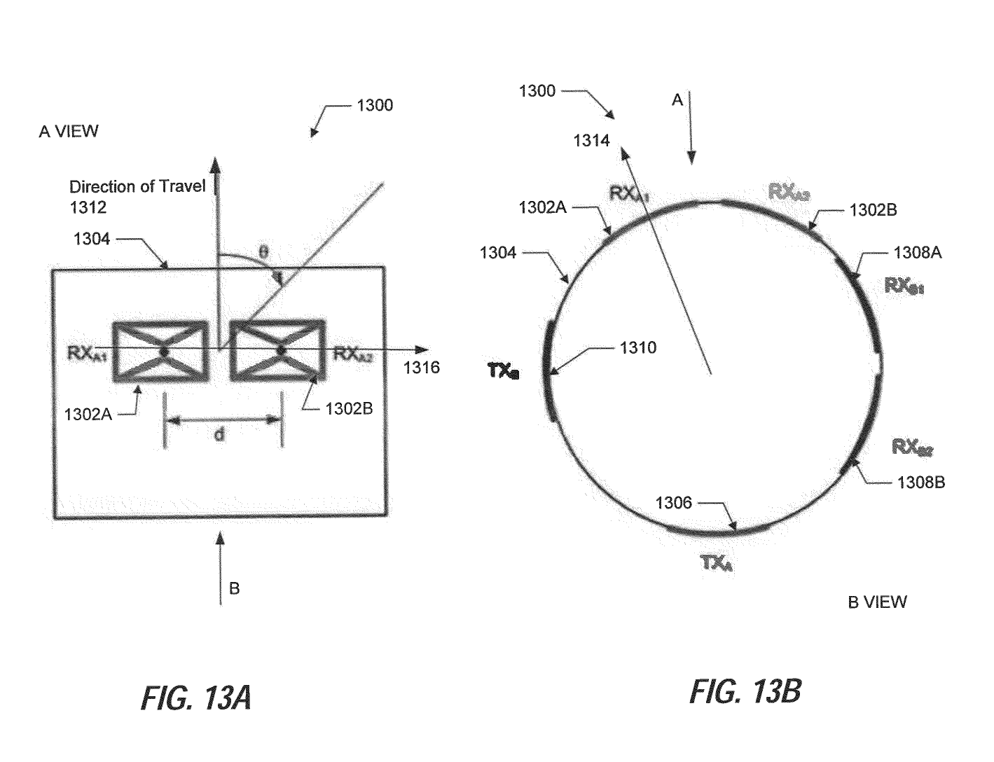

FIG. 13A illustrates a lateral view (A view) of an antenna system 1300 for forward-looking proximity sensor disposed on a section of a carrier platform 1304, according to an embodiment. FIG. 13B illustrates an end view (B view) of antenna system 1300, according to another embodiment. As shown in FIGS. 13A and 13B, antenna system 1300 includes a receiving array and a transmitting array. Receiving array may include a plurality of receiving antenna elements 1302A and 1302B. Transmitting array may include one or more transmitting antenna elements 1306. Receiving antenna elements 1302A and 1302B and transmitting antenna element 1306 may be disposed on one or more side surfaces of carrier platform 1304. Antenna elements 1302A, 1302B, and 1306 may each include a metal sheet that is curved to conform to a shape of the side surfaces of carrier platform 1304. The metal sheet of each antenna element may be oriented to face a first direction 1314 that is substantially perpendicular to the direction of travel 1312 of carrier platform 1304. In one embodiment, carrier platform 1304 may have a cylindrical body. Antenna elements 1302A, 1302B, and 1306 may each form an arch structure that follows a curvature of the cylindrical body of carrier platform 1304. Antenna elements 1302A, 1302B, and 1306 may also be formed into other shapes as desired to fit a particular application.

According to an embodiment, as shown in FIG. 13A, receiving antenna elements 1302A and 1302B may be arranged on carrier platform 1304 along a second direction 1316 that is substantially perpendicular to the direction of travel 1312 of carrier platform 1304. Receiving antenna elements 1302A and 1302B may be separated from each other by a distance of d (measured from center to center) along second direction 1316. The transmitting array and the receiving array and may be disposed on opposite side surfaces of carrier platform 1304 so that they are 180 degrees apart. The transmitting array and the receiving array of antenna system 1300 may form a forward-looking two-way beam pattern in the direction of travel 1312 of carrier platform 1304.

According to an embodiment, antenna system 1300 may include more than one pair of transmitting array and receiving array as shown in FIG. 13B, each corresponding to a channel. For example, antenna system 1300 may include two pairs of transmitting array and receiving array. The first of the two pairs of arrays including receiving elements 1302A and 1302B and transmitting element 1306 may be disposed on top and bottom side surfaces of carrier platform 1304, respectively. The second of the two pairs of arrays including receiving elements 1308A and 1308B and transmitting element 1310 may be disposed substantially 90 degrees apart from the first pair and on left and right side surfaces of carrier platform 1304, respectively. Antenna system 1300 may include more than two pairs of transmitting array and receiving array that are disposed on the side surfaces of carrier platform 1304 at substantially equal angular intervals. The proximity sensor may include one or more switching elements for selecting one of the pairs of arrays at a time. The switching elements may switch among the channels based on a coherent processing interval (CPI) of the proximity sensor. In a further embodiment, for each channel, additional antenna elements may be added to allow polarization diversity and to mitigate shadowing effects on relatively large carrier platforms.

According to an embodiment, antenna system 1300 may allow the proximity sensor described herein to determine an angle of arrival of a target with respect to the direction of travel 1312. For example, the first pair of transmitting array and receiving array disposed on the top and bottom surfaces of carrier platform 1304 may generate signals indicating an angle of arrival of the target in a horizontal plane. The second pair of transmitting array and receiving array disposed on the left and right surfaces of carrier platform 1304 may generate signals indicating an angle of arrival of the target in a vertical plane. When antenna system 1300 includes more than two pairs of transmitting array and receiving array, each pair may be configured to generate signals indicating a corresponding angle of arrival.

According to a further embodiment, each transmitting antenna element (e.g., 1306, 1310) may be configured to generate RF signals with a forward-looking beam pattern. When the RF signals are returned from the target, receiving antenna elements (e.g., 1302A, 13028, 1308A, 1308B) each receives a portion of the returned signals and provide the returned signals to the processing unit of the proximity sensor to determine the corresponding angle of arrival of the target. The processing unit may analyze the returned signals from the receiving antenna elements and determine the angle of arrival based on, for example, a propagation time difference or a phase difference between the returned signals received at different receiving antenna elements.

In one embodiment, the angle of arrival θ corresponding to a particular pair of transmitting array and receiving array may be determined by solving the following equation:

$$Δϕ = \frac{2 π}{λ} d sin ( θ ) ,$$

where Δφ is the phase difference between returned signals received by different receiving elements and λ is the wavelength of the carrier waveform. Each channel of antenna system 1300 may have a field of view (FOV) determined according to the following equation:

$${θ}_{F O V} = {sin}^{- 1} ( \frac{λ}{2 d} ) .$$

Parameter λ and d may be chosen to provide a desired field of view for a particular application. A target located outside the field of view may be wrapped into the first ambiguity region of the antenna system 1300. For target outside of the field of view, a cue for the angle of arrival of target may be provided to the proximity senor to make correct determination.

In an embodiment, the variance of the angel of arrival determined based on antenna system 1300 may be determined based on the following equation:

$${σ}_{θ}^{2} = {( \frac{λ}{2 π d} )}^{2} \frac{1}{S N R} ,$$

where SNR represents the signal-to-noise ratio at the receiving elements, Thus, λ and d may be adjusted to provide a desired measurement accuracy for the angle of arrival

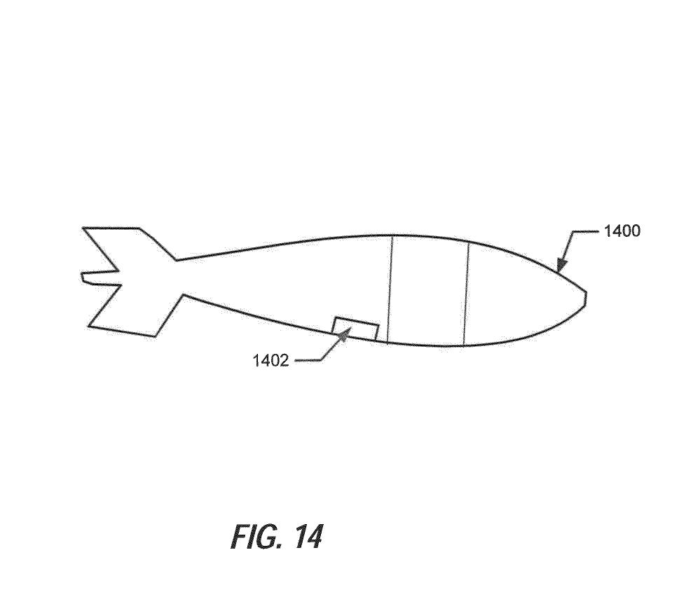

FIG. 14 depicts another exemplary embodiment of proximity sensor 1402. Proximity sensor 1402 may be disposed anywhere volume is available within carrier platform 1400. Antenna elements for proximity sensor 1402, similar to those shown in FIG. 10, may be co-located with electronics package or routed to other portions of carrier platform 1400 based on design requirements. The antenna elements may be placed on carrier platform 1400 in such a way as not to interfere with normal function(s) of carrier structure 1400 or other components. In addition, antenna elements may be tangential to surface of carrier platform 1400 and formed to curvature of body of carrier platform 1400. Antenna element(s) may include rolled copper plate with etched circuitry.

According to a still further embodiment, proximity sensor described herein may operate as height-of-burst (HOB) sensor for carrier platform. Projectiles or missiles designed to be aimed at targets, such as those on the ground, often require an HOB sensor, i.e., a target detection device (TDD), to fire or fuze warhead of missile at a height of a few meters from target to increase lethality. Proximity sensor disclosed herein may provide accurate measurement of height as missile approaches the targeted surface and generate accurate warhead fire signal when missile reaches a predetermined height above targeted surface. Proximity sensor may allow firing solution to be robust in terms of abilities to withstand very high-g accelerations, storage life, and performance in the presence of countermeasures, while being low cost and small size. Proximity sensor may also be configured to differentiate targets in complex scenes, handle diverse fall angles of the missile, and provide increased accuracy for aim points and reduced susceptibility to environmental effects.

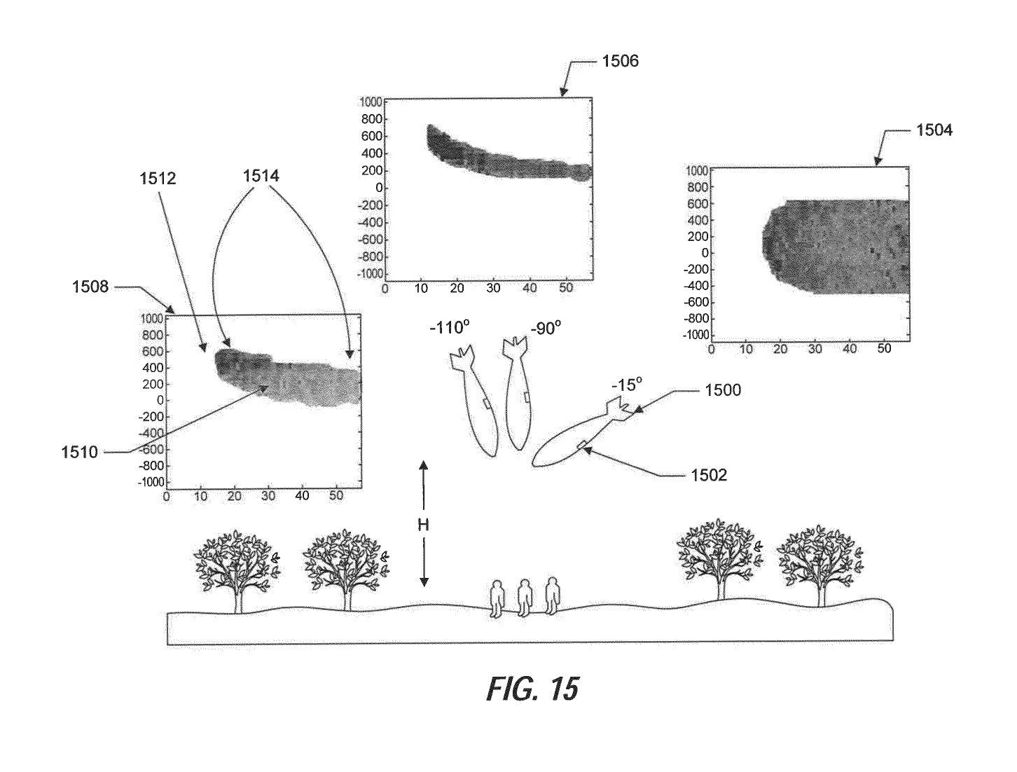

FIG. 15 shows three different fall angles of a carrier platform 1500 equipped with HOB sensor 1502, which may be implemented by proximity sensors described above, according to an embodiment, HOB sensor 1502 may generate range-Doppler image corresponding to given height and fall angle. FIG. 15 illustrates three range-Doppler images 1504, 1506, and 1508 for the three different fall angels at −15°, −90°, and −110°, respectively, when carrier platform is at height H above ground surface.

Each of range-Doppler images includes an image pattern (e.g., image pattern 1510) representing the ground surface within the field-of-view of sensor 1502. The height H of carrier platform is indicated by range of closest signal return (e.g., point 1512 in range-Doppler image 1508). Ground signal return may be distributed over range 1514, also known as ground spreading, because ground surface within field-of-view of sensor 1502 falls within range 1514.

Image pattern corresponding to ground surface may be a function of fall angle. For example, when fall angle of missile 1500 is near incident (e.g., −90°), ground spreading in range-Doppler image is minimum. When missile 1500 has a flatter trajectory with, for example, a fall angel of −15°, ground spreading is maximum. Thus, by analyzing image feature of range-Doppler image, HOB sensor 1502 may determine height and fall angle of missile body with respect to ground surface. Upon determining that carrier platform 1500 reaches predetermined height above ground surface, HOB sensor 1502 may generate signal to adjust operation of carrier platform 1500. For example, HOB sensor 1502 may generate detonation signal to fuze warhead onboard carrier platform 1500, thereby maximizing lethality for target on ground surface.

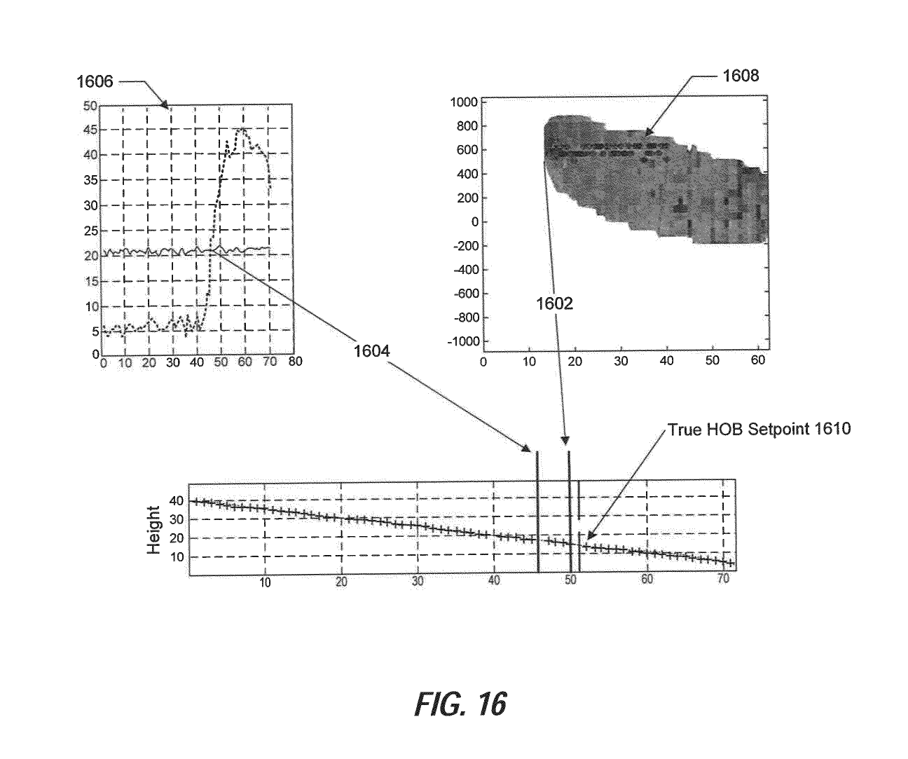

According to a further embodiment, HOB sensor 1502 may use tracking filter to estimate characteristics, such as range or range rate, of image feature 1510. Tracking filter may minimize or eliminate effects of amplitude variation on track and reduce the effects of noise and interference by discounting tracks that cannot be valid due to the physics of the engagement. FIG. 16 illustrates exemplary track points 1608 for tracking based on range-Doppler image generated by HOB sensor 1502.

FIG. 16 further illustrates height of burst 1602 determined by HUB sensor 1502 compared with height of burst 1604 determined by conventional HOB sensor using single bin filter 1606. Due to noise and variation, conventional HOB sensor tends to produce an imprecise result, while HOB sensor 1502 generates an HOB set point that is substantially equal or closer to the true value 1610 of the desired height.

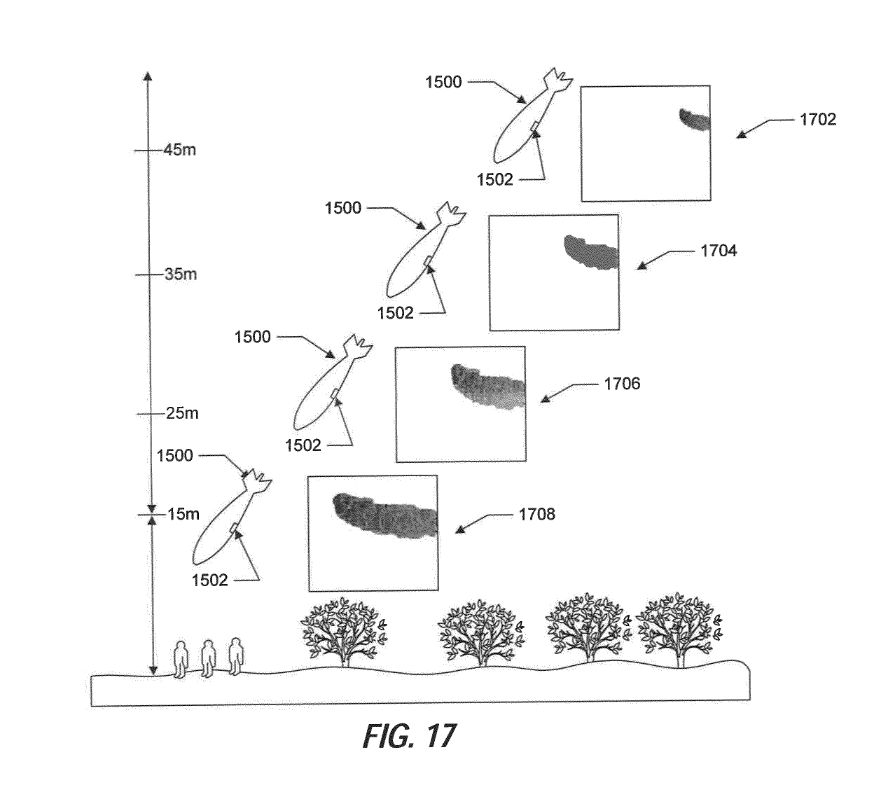

FIG. 17 illustrates a tracking of the height H by HUB sensor 1502 when carrier platform 1500 approaches the ground surface. Exemplary range-Doppler images 17024708 are shown corresponding to heights at 45 meters, 35 meters, 2.5 meters, and 15 meters, respectively. As carrier platform 1500 approaches ground surface, image feature corresponding to ground surface moves to closer range bins. At the same time, the strength of the reflected signal becomes greater because of reduced distance between carrier platform 1500 and the ground surface. In addition, HOB sensor 1502 may implement feature identification and suppression in analyzing range-Doppler images to suppress effects of any countermeasures or undesired environments such as foliage and adverse weather.

According to a further embodiment, HOB sensor 1502 is configured to operate in single-set-point mode as further shown in FIG. 17. In single-set-point mode, preset HOB set point, such as 15 meters, may be set in HOB sensor 1502. HOB sensor 1502 may continue to measure and track the height of carrier platform 1500 above the ground surface as the closest point on the ground to the antenna array disposed on the carrier platform. HOB sensor 1502 operating in single-set-point mode uses preset HOB set point as a single threshold to determine whether fuze commend should be generated to adjust the operation of carrier platform, such as detonating warhead carried by carrier platform 1500. The HUB set point may be defined within the two-dimensional range-Doppler map. For example, the HOB set point may be a user-selected point on the range axis that corresponds to a Doppler velocity of zero. Alternatively, the HOB set point may correspond to a non-zero range and a non-zero Doppler velocity. HOB sensor 1502 may monitor the image of the ground surface in the range-Doppler map and determine whether the image of the ground surface matches the HOB set point.

In an embodiment, antenna array may be located near warhead carried by carrier platform 1500 such that the distance between the front end of carrier platform 1500 and antenna array may be negligible. In another embodiment, antenna array may be disposed at remote location from warhead. In this embodiment, HOB sensor 1502 may first estimate a fall angle by, for example, analyzing image feature in range-Doppler image sequence. HOB sensor 1502 may then determine height of front end of carrier platform 1500 based on range provided by range-Doppler image and distance between antenna array and warhead.

In addition to single-set-point mode, HOB sensor 1502 may also be configured to operate in multiple-set-point mode. In multiple-set-point mode, HOB sensor 1502 may provide an accurate HOB measurement in a stressing environment including uneven ground features such as trees, hills, buildings, etc. In this embodiment, HOB sensor 1502 may differentiate undesired ground features from true ground target and issue a fuze command at the correct HOB. In particular, HOB sensor 1502 may define a plurality of set points in the range-Doppler map and determine whether the image of the ground surface in the range-Doppler map matches the plurality of set points. The plurality of set points may be designed to ensure accurate identification of the ground surface in stressing environments.

According to some embodiments, proximity sensor disclosed herein may be used on any type of vehicle including automobiles, vessels, or aircrafts to detect other vehicles or pedestrians. For example, proximity sensor may be adopted and installed on a vehicle for: detecting a potential collision; and/or triggering an alarm signal to warn an operator. Signals provided by proximity sensor may be further used to control or guide vehicle, vessel, or aircraft to a destination or target or to avoid the potential collision with objects or hazards. For example, proximity sensor may provide signals to computer system, which determines, based on signals, whether vehicle comes within predetermined distance from other Objects such as another vehicle, a pedestrian, a building, etc. Proximity sensor may further identify different portions of an object within predetermined detection distance, thereby causing on-board computer system to control vehicle in response to signals provided by sensor.

As another example, the proximity sensor may be used to guide a manned or unmanned vehicle, vessel, or aircraft to a particular location or along a particular route. For example, the proximity sensor may identify a particular location and provides signals to on-board computer system, reflecting an estimation of distance between the vehicle and the particular location, object, or hazard. The on-board computer system may then issue commands to control the vehicle based on signals provided by proximity sensor. Alternatively, proximity sensor may identify predetermined route or characteristics thereof, and provide signals to on-board computer system to guide vehicle along predetermined route.

According to another embodiment, proximity senor described herein may be integrated with package processing system for detecting and identifying packages or a manufacturing system for handling products during a manufacturing process. For example, package processing system may include automatic transportation unit, such as conveyer belt, for transporting packages through the system. Package processing system may further include a number of processing units, such as robotic arms, labeling machines, etc., for handling packages. One or more proximity sensors similar to those described herein may be installed in the system for detecting whether a package is transported to a predetermined processing unit. A proximity sensor at processing unit may determine distance and speed of package with respect to processing unit and estimate amount of time required for package to reach processing unit. Processing unit may then prepare to handle package according to the estimations.

Additionally, proximity sensor may determine characteristics of package, such as size, shape, materials, etc., and instruct processing unit to handle packages according to characteristics of package(s). For example, processing unit may separate packages into different categories according to size, shape, etc. Processing unit may also apply different labels to packages depending on size, shape, materials, etc. Because proximity sensor may distinguish different portions of the package, it may further instruct processing unit to handle a particular portion of package.

According to an embodiment, proximity sensor described herein may perform a Power-Up Built-In-Test (PBIT) including verification of communication interfaces, VCO calibration, and receiver noise checks. Proximity sensor may also perform additional Transmit/Receive Built-In-Test (TRBIT) mode, which requires less than 2 ms to complete verification of transmitter and receiver status with a delay line test.

When proximity sensor operates as HOB sensor, it may be configured to track the fall rate of carrier platform and maintain a real-time height of carrier platform over the ground surface. Fuze trigger latencies due to finite driver rise time can be removed and the fuze trigger may be much less than one microsecond from HOB detection.

Other embodiments of the disclosure will be apparent to those skilled in the art from consideration of the specification and practice of the disclosure. It is intended that the specification and examples be considered as exemplary with a true scope and spirit of the invention being indicated by the following claims.

What is claimed is:

1. A forward-looking proximity sensor, comprising;
one or more antenna elements mounted on a carrier platform in a lateral direction of said carrier platform, said antenna elements being configured to transmit a modulated signal in said direction of travel of said carrier platform, said antenna elements receiving a reflected portion of said modulated signal from a target; and
a processing unit configured to generate said modulated signal based on a baseband signal and a carrier signal, said processing unit further determining characteristics of said target based on said reflected portion of said modulated signal, said characteristics of said target indicating a range of said target and at least one feature of said target.

2. The forward-looking proximity sensor of claim 1, wherein the processing unit is further configured to form an image including a representation of the target based on the reflected portion of the modulated signal, the image including a first dimension representing ranges of objects within a field of view and a second dimension representing speeds of objects within the field of view.

3. The forward-looking proximity sensor of claim 2, wherein the processing unit is configured to determine the distance and the feature of the object based on the image.

4. The forward-looking proximity sensor of claim 2, wherein the processing unit is configured to select a first point of the image corresponding to a first feature of the target for tracking the target.

5. The forward-looking proximity sensor of claim 4, wherein the processing unit is configured to select a second point of the image corresponding to a second feature of the target for aiming a weapon at the target.

6. The forward-looking proximity sensor of claim 2, wherein the processing unit is configured to compare the distance of the target with a threshold distance and generate a command for adjusting an operation of the carrier platform when the distance of the target is less than the threshold distance.

7. The forward-looking proximity sensor of claim 2, wherein the processing unit is configured to identify, based on the image, the target among the objects within the field of view.

8. The forward-looking proximity sensor of claim 7, wherein the processing unit is configured to identify the target based on a plurality of set points defined in the image.

9. The forward-looking proximity sensor of claim 8, wherein the processing unit is configured to identify the target when the representation of the target matches the plurality of set points.

10. The forward-looking proximity sensor of claim 7, wherein at least one of the set points corresponds to a preset range and a speed of zero.

11. The forward-looking proximity sensor of claim 10, wherein the set region corresponds to a preset non-zero range and a preset non-zero speed.

12. The forward-looking proximity sensor of claim 1, wherein the antenna elements include a plurality of metal sheets conformed to a shape of the carrier platform and configured to form a two-way forward-looking beam pattern in the direction of traveling of the carrier platform.

13. The forward-looking proximity sensor of claim 1, wherein the target includes a ground surface and the range of the target indicates a height of the carrier platform above the ground surface.

14. The forward-looking proximity sensor of claim 1, wherein the target includes at least one of an airborne object, an automobile, a vessel, a pedestrian, or an object carried by a conveyer.

15. The forward-looking proximity sensor of claim 1, further comprising:
a voltage-controlled oscillator configured to generate the carrier signal having a frequency; and
a signal divider configured to separate a portion of the carrier signal,
wherein the processor is further configured to control the voltage-controlled oscillator according to the separated portion of the carrier signal and the voltage-controlled oscillator varies the frequency of the carrier signal within a set frequency range.

16. The forward looking proximity sensor of claim 1, wherein the characteristics of the target include an angle of arrival of the target with respect to the direction of travel of the carrier platform.

17. A method of detecting proximity of a target, comprising:
forming a modulated signal based on a baseband signal and a carrier signal;
transmitting the modulated signal through one or more antenna elements towards a target in a direction of travel of a carrier platform, said one or more antenna elements being mounted on said carrier platform in a lateral direction of said carrier platform;
receiving a reflected portion of said modulated signal from said target; and
determining characteristics of said target based on said portion of said reflected portion of said modulated signal, said characteristics of said target indicating a distance to said target and at least one feature of said target.

18. The method of claim 17, further comprising forming an image including a representation of the target, the image including a first dimension representing ranges of objects within a field of view and a second dimension representing speeds of the objects within the field of view.

19. The method of claim 18, further comprising:
defining a plurality of set points in the image;
determining that the representation of the target matches the set points; and
generating a command for adjusting operation of the carrier platform.

20. The method of claim 17, wherein the characteristics of the target include an angle of arrival of the target with respect to the direction of travel of the platform.

21. A system for detecting a target, comprising:
a carrier platform traveling in a direction; and
a forward-looking proximity sensor disposed on said carrier platform, said forward looking proximity sensor comprising:
one or more antenna elements mounted on said carrier platform in a lateral direction of said carrier platform and configured to transmit a modulated signal in said direction of travel of said carrier platform, said antennas elements receiving a reflected portion of said modulated signal from said target; and
a processing unit configured to generate said modulated signal based on a baseband signal and a carrier signal, the processing unit further determining characteristics of said target based on said reflected portion of said modulated signal, said characteristics of said target indicating a distance of said target and at least one feature of said target.

22. The system of claim 21, wherein the carrier platform is a projectile having a cylindrical body and the antenna elements include a plurality of metal sheets conformed to the cylindrical body of the carrier platform.
